(19) United States
(12) Patent Application Publication
(10) Pub. No.: US 2003/0116194 A1
(43) Pub. Date: Jun. 26, 2003

(54) Fuel supply pump

(75) Inventor: Masayori Ishimoto, Saitama (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: BOSCH AUTOMOTIVE SYSTEMS CORPORATION, Higashimatsuyama-shi (JP)

(21) Appl. No.: 10/308,371

(22) Filed: Dec. 3, 2002

(30) Foreign Application Priority Data
Dec. 21, 2001 (JP) 2001-388840

(51) Int. Cl. F16L 7/00

(52) U.S. Cl. 137/375

(57) ABSTRACT

There is provided a fuel supply pump that is capable of keeping the function of an outlet valve thereof normal over a long time period even when a low lubricity fuel is used. The fuel supply pump has an outlet valve slidably inserted in an insertion hole formed in a valve body, for opening and closing the insertion hole. The outlet valve is coated by CVD coating.

### BACKGROUND OF THE INVENTION

1. Field of the Invention

This invention relates to a fuel supply pump, and more particularly to a fuel supply pump that is suitably used as a supply pump for a common-rail fuel injection system.

2. Description of the Prior Art

Conventionally, there has been proposed a fuel supply pump having an outlet valve slidably inserted in an insertion hole of a valve body, for opening and closing the insertion hole (e.g. in Japanese Laid-Open Patent Publication (Kokai) No. 2001-214829).

In the fuel supply pump of the above-mentioned kind, high pressure is maintained downstream of the outlet valve. Therefore, when the outlet valve is opening or closing the insertion hole, the high pressure acts on the outlet valve and the valve body.

For this reason, the sliding portions of the outlet valve and the valve body have been conventionally prone to wear. Particularly when a low lubricity fuel is used as fuel, the outlet valve and the valve body are rapidly worn so that their service lives are made markedly short. Further, when the outlet valve and the valve body are worn, the function of the outlet valve is degraded, which may causes engine stall or engine starting failure.

### SUMMARY OF THE INVENTION

It is an object of the invention to provide a fuel supply pump that is capable of keeping the function of an outlet valve thereof normal over a long time period even when a low lubricity fuel is used.

To attain the above object, the invention provides a fuel supply pump including a valve body, and an outlet valve slidably inserted in an insertion hole formed in the valve body, for opening and closing the insertion hole,

wherein the outlet valve is coated by CVD coating.

According to this fuel supply pump, since the outlet valve is coated by CVD coating, it is possible to reduce the amounts of wear of the outlet valve and the valve body even when a low lubricity fuel is used.

Preferably, the outlet valve has a sliding surface in contact with an inner peripheral surface of the insertion hole, and a seating surface for abutment with an outlet-side opening edge of the insertion hole, and a film is formed on the sliding surface by CVD coating.

According to this preferred embodiment, since the outlet valve has the film formed on the sliding surface thereof by CVD coating, it is possible to reduce the amounts of wear of the outlet valve and the valve body even when a low lubricity fuel is used.

More preferably, a film is formed on the seating surface by CVD coating

According to this preferred embodiment, since the outlet valve has the film formed on the seating surface and on the sliding surface thereof by CVD coating, it is possible to reduce the amounts of wear of the outlet valve and the valve body even when a low lubricity fuel is used.

Preferably, the outlet valve has a sliding surface in contact with an inner peripheral surface of the insertion hole, and a seating surface for abutment with an outlet-side opening edge of the insertion hole, and a film is formed on the seating surface by CVD coating.

According to this preferred embodiment, since the outlet valve has the film formed on the seating surface thereof by CVD coating, it is possible to reduce the amounts of wear of the outlet valve and the valve body even when a low lubricity fuel is used.

Preferably, the fuel supply pump includes an inlet valve slidably fitted in the outlet valve, for opening and closing an inlet passage formed in the valve body.

According to this preferred embodiment, the inlet valve is slidably fitted in the outlet valve capable of smoothly sliding in the insertion hole over a long time period due to CVD coating provided thereon. This makes the inlet valve hard to fall or incline, and hence the function of the inlet valve is maintained over the long time period.

The above and other objects, features and advantages of the present invention will become more apparent from the following description taken in conjunction with the accompanying drawings.

### BRIEF DESCRIPTION OF THE DRAWINGS

FIG. 1 is an enlarged cross-sectional view of an essential part of a fuel supply pump according to an embodiment of the invention;

FIG. 2 is a cross-sectional view taken on line II-II of FIG. 1;

FIG. 3 is a cross-sectional view taken on line III-III of FIG. 4;

FIG. 4 is a side view of the fuel supply pump;

FIG. 5 is a plan view of the fuel supply pump;

FIG. 6 is a circuit diagram of a common-rail fuel injection system including the fuel supply pump;

FIG. 7 is a graph showing changes in the amount of wear of a sliding surface of an outlet valve of the fuel supply pump occurring with the lapse of time; and

FIG. 8 is a graph showing changes in the amount of wear of a seating surface of the outlet valve of the fuel supply pump occurring with the lapse of time.

### DETAILED DESCRIPTION OF THE PREFERRED EMBODIMENT

The invention will now be described in detail with reference to drawings showing a preferred embodiment thereof.

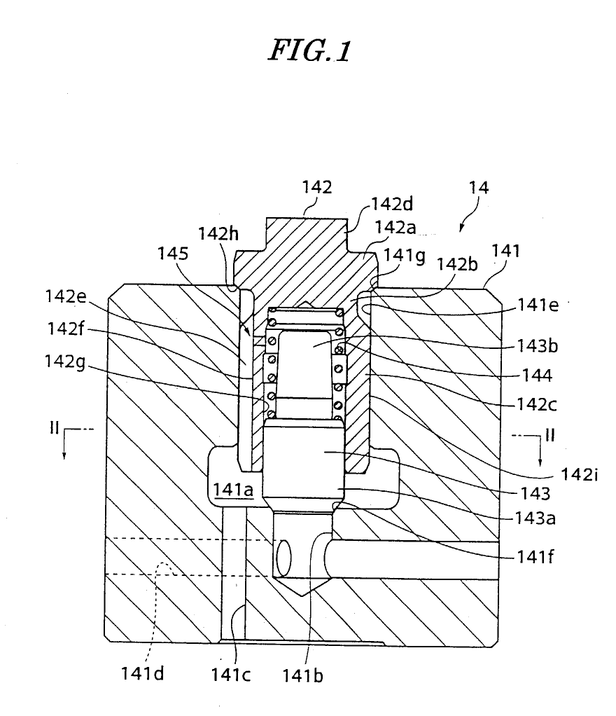

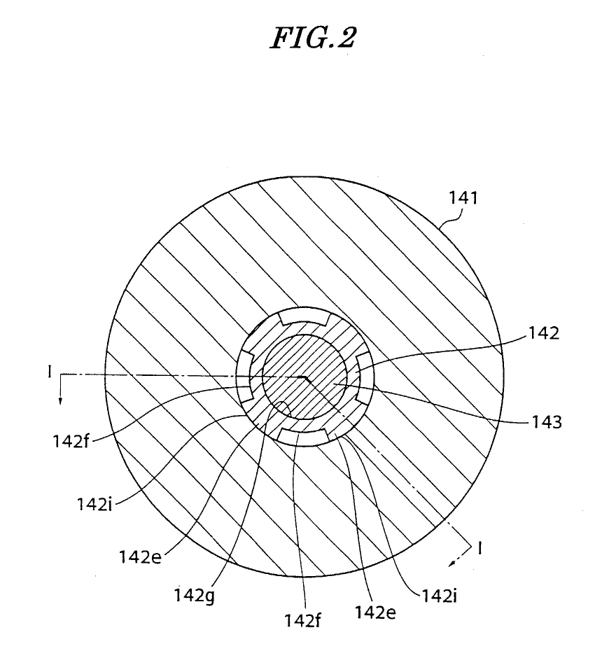

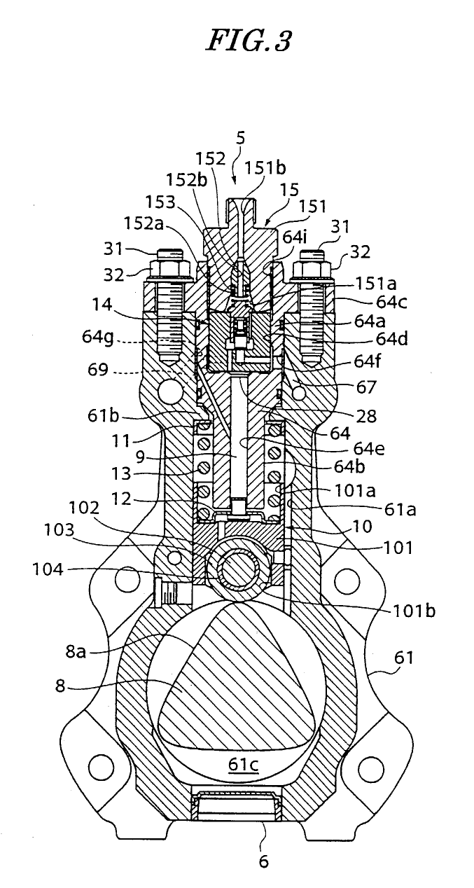

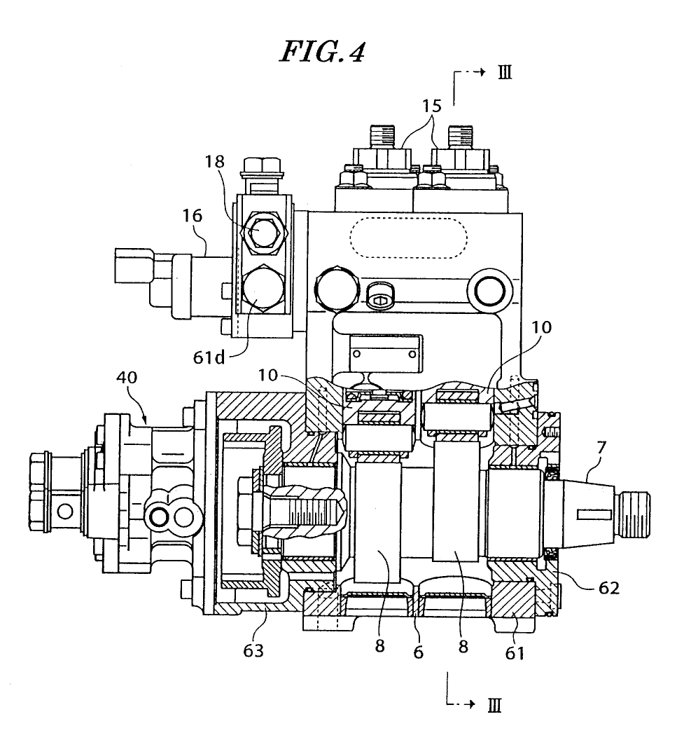

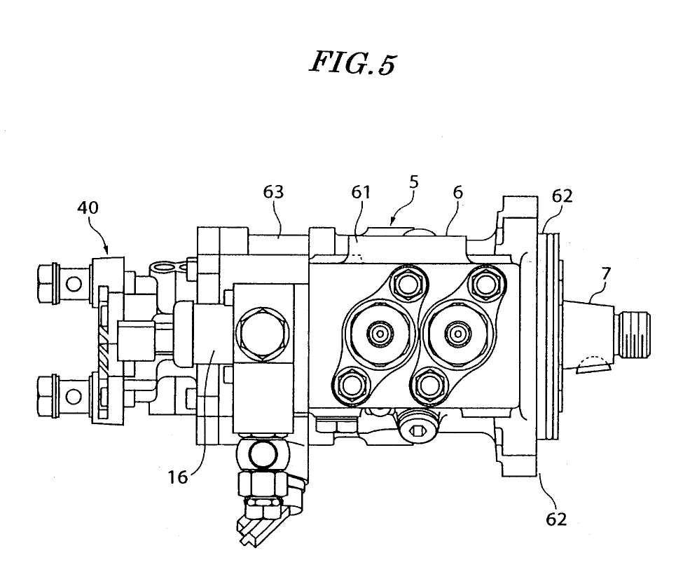

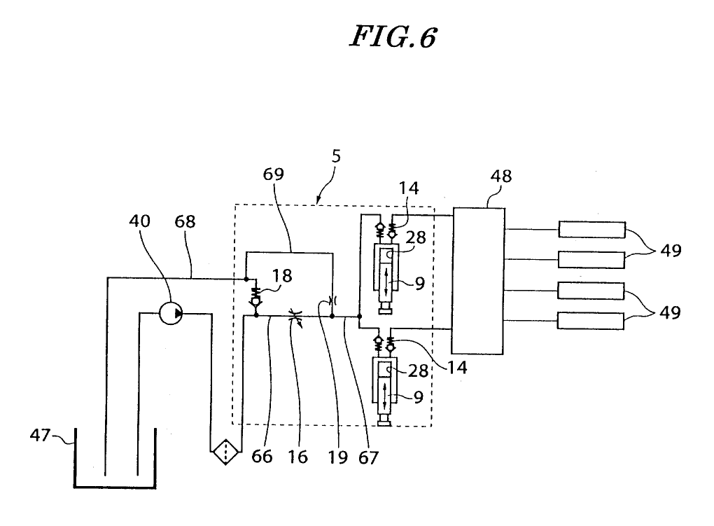

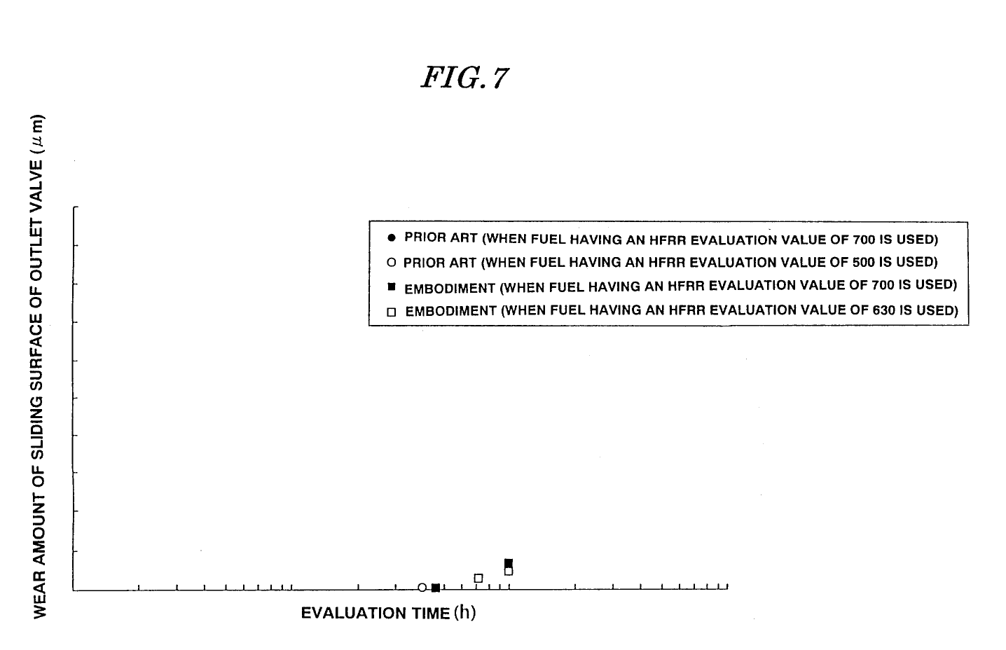

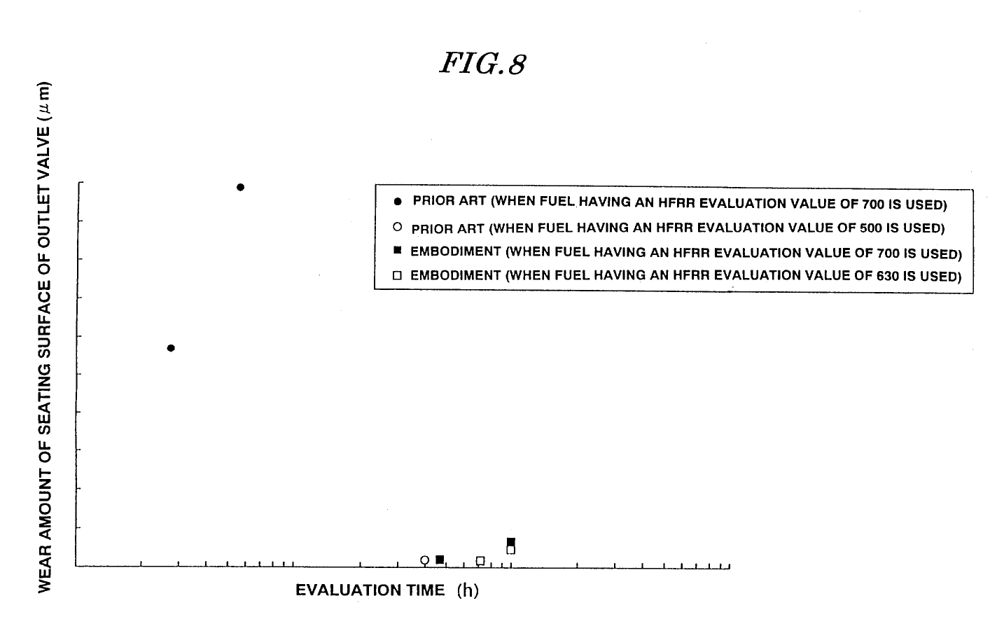

FIG. 1 is an enlarged cross-sectional view of part of a fuel supply pump according to the embodiment of the invention. FIG. 2 is a cross-sectional view taken on line II-II of FIG. 1, while FIG. 3 is a cross-sectional view taken on line III-III of FIG. 4. FIG. 4 is a side view of the fuel supply pump, and FIG. 5 is a plan view of the same. FIG. 6 is a circuit diagram of a common-rail fuel injection system including the fuel supply pump. Further, FIG. 7 is a graph showing changes in the amount of wear of a sliding surface of the outlet valve of the fuel supply pump occurring with the lapse of time, while FIG. 8 is a graph showing changes in the amount of wear of a seating surface of the same occurring with the lapse of time.

The fuel supply pump of the embodiment is used as a supply pump for the common-rail fuel injection system. As shown in FIG. 6, the fuel supply pump sucks fuel from a fuel tank 47, pressurizes the fuel, and then supplies the high-pressure fuel to a common rail 48.

The fuel supply pump is comprised of a high-pressure pump 5 and a feed pump 40.

The high-pressure pump 5 includes a housing 6, a shaft 7, cams 8, plungers 9, tappets 10, springs 13, I/O valves 14, valve holders 15, a proportional control valve 16, and an overflow valve 18.

The housing 6 has a main housing 61, a front housing 62, a rear housing 63, and plunger barrels 64.

The main housing 61 is formed with two holes 61a extending along the height thereof and arranged side by side with respect to the axial direction along the shaft 7. Each of the holes 61a has an inner peripheral surface thereof formed with an annular projection 61b projecting radially inward. The main housing 61 has a lower portion defining a cam-receiving chamber 61c continuous with the holes 61a.

The front housing 62 closes an opening in the front face of the main housing 61, while the rear housing 63 closes an opening in the rear face of the same.

Each plunger barrel 64 has a generally hollow cylindrical shape and includes a large-diameter portion 64a, a small-diameter portion 64b, a flange portion 64c, a valve-receiving hole 64d, a plunger-receiving hole 64e, a passage portion 64f, and a passage portion 64g. The plunger barrels 64 are inserted in the two holes 61a, respectively. The large-diameter portion 64a is arranged on an upper side of the projection 61b, while the small-diameter portion 64b formed continuously with a lower end of the large-diameter portion 64a is arranged on a lower side of the projection 61b. The flange portion 64c is formed in a manner continuous with an upper end of the large-diameter portion 64a and fixed to an upper end face of the main housing 61 by bolts 31 and nuts 32. The valve-receiving hole 64d is formed in an upper portion of the plunger barrel 64, while the plunger-receiving hole 64e is formed in a lower portion of the plunger barrel 64. The plunger-receiving hole 64e is smaller in diameter than the valve-receiving hole 64d, and continuous with the same. The passage portion 64f extends in the large-diameter portion 64a and forms part of a second supply passage 67, referred to hereinafter. The passage portion 64g also extends in the large-diameter portion 64a and forms part of a second return passage 69, referred to hereinafter.

As shown in FIG. 6, a first supply passage 66 and the second supply passage 67 as well as a first return passage 68 and the second return passage 69 extend through the housing 6.

Fuel delivered from the feed pump 40 flows into the first supply passage 66 via an inlet port 61d (see FIG. 5).

Fuel having passed through the proportional control valve 16 flows into the second supply passage 67.

The overflow valve 18 is arranged in one end of the first return passage 68, which is connected to the first supply passage 66, and the other end of the first return passage 68 is connected to the fuel tank 47.

On the other hand, the second return passage 69 has one end thereof connected to the second supply passage 67 and the other end thereof connected to the first return passage 68.

The shaft 7 has a front end portion extending through the front housing 62. The front housing 62 rotatably supports the shaft 7 via a bearing, not shown. The rear end portion of the shaft 7 extends through the rear housing 63 and is connected to the feed pump 40. The rear housing 63 rotatably supports the shaft 7 via a bearing, not shown.

The cams 8 are provided in pair and mounted on the shaft 7 at respective locations below the plunger-receiving holes 64e. The cams 8 are each formed to have a generally triangular shape. The mounting angle of the front cam 8 with respect to the shaft 7 and that of the rear cam 8 with respect to the same are different from each other by 180 degrees.

The plungers 9 are slidably inserted in the respective plunger-receiving holes 64e. A plunger chamber 28 is defined between an upper end face of each plunger 9 and a lower end face of the I/O valve 14 associated therewith.

The tappets 10 are arranged in the respective holes 61a in a vertically movable manner. The tappets 10 are each comprised of a slider 101, a pin 102, and a roller 103. The slider 101 has an upper portion thereof formed with a spring seat-receiving portion 101a and a lower portion thereof formed with a roller-receiving portion 101b. The pin 102 is mounted in the lower portion of the slider 101 such that it extends through the roller-receiving portion 101b in parallel with the shaft 7. The roller 103 is rotatably mounted on the pin 102 via a bearing 104.

A first spring seat 11 is arranged on a lower surface of each projection 61b.

A second spring seat 12 is mounted on a lower end of each plunger 9 and received in the spring seat-receiving portion 10a of the slider 101 associated therewith.

A spring 13 is arranged between the first spring seat 11 and the second spring seat 12, for urging the plunger 9 and the tappet 10 toward the cam 8 via the second spring seat 12.

The I/0 valves 14 are each received in the valve-receiving hole 64d of the plunger barrel 64. As shown in FIG. 1, each of the I/0 valves 14 is comprised of a valve body 141, an outlet valve 142, an inlet valve 143, and a spring 144.

The valve body 141 includes a chamber 141a, an inlet passage 141b, a communication passage 141c, an outflow passage 141d, and an insertion hole 141e. The direction of fuel supply is switched in the chamber 141a. The inlet passage 141b communicates between the second supply passage 67 and the chamber 141a. The inlet passage 141b has one end thereof formed with a valve seat surface 141f. The communication passage 141c communicates between the chamber 141a and the plunger chamber 28. The insertion hole 141e is formed in an upper central portion of the valve body 141, and continuous with the chamber 141a. The insertion hole 141e has one end thereof formed with a valve seat surface 141g.

The outlet valve 142 includes a valve portion 142a, a neck portion 142b, an insertion portion 142c, and a mounting portion 142d. The valve portion 142a is positioned on the valve seat surface 141g, for opening and closing an outlet passage 145, referred to hereinafter. The valve portion 142a has a seating surface 142h which is brought into abutment with the valve seat surface 141g of the valve body 141. The neck portion 142b extends from the lower end of the valve portion 142a. The outer diameter of the neck portion 142b is smaller than those of the valve portion 142a and the insertion portion 142c. The insertion portion 142c extends downward from the neck portion 142b and is slidably inserted in the insertion hole 141e. As shown in FIG. 2, the insertion portion 142c has an outer peripheral surface thereof formed with vanes 142e at circumferentially equal intervals, and slits 142f are formed between respective adjacent pairs of the vanes 142e. The vanes 142e each have a sliding surface 142i in contact with the insertion hole 141e. The outlet passages 145 are defined by the slits 142f and the inner peripheral surface of the insertion hole 141e. The insertion portion 142c has a central portion thereof formed with an insertion hole 142g. The mounting portion 142d is formed on an upper end of the valve portion 142a.

The surface of the outlet valve 142 is coated by a CVD (chemical vapor deposition) process. It is preferred that the thickness of a film formed by the CVD coating is two to three micrometers.

The inlet valve 143 has a valve portion 143a and a mounting portion 143b. The most part of the inlet valve 143 is fitted in the insertion hole 142g of the outlet valve 142. The valve portion 143a has an end portion projecting from the insertion hole 142g and positioned on the seat surface 141f of the valve body 141, for opening and closing the inlet passage 141b. The mounting portion 143b is formed on an upper end of the valve portion 143a.

The spring 144 is mounted on the mounting portion 143b of the inlet valve 143 and received in the insertion hole 142g of the outlet valve 142 together with the mounting portion 143b. The spring 144 constantly urges the inlet valve 143 toward the seat surface 141f.

The valve holders 15 are each comprised of a holder body 151, a spring seat 152, and a spring 153.

The holder body 151 is screwed into an internal thread 64i formed in an upper portion of the valve-receiving hole 64d of the plunger barrel 64, to fix the valve body 141 of the I/O valve 14 to the plunger barrel 64 associated therewith. The holder body 151 is formed therein with a receiving hole 151a and an outlet passage 151b. The receiving hole 151a is formed in a lower central portion of the holder body 151. The outlet valve 142 is received in the receiving hole 151a in a vertically movable manner. The outlet passage 151b is formed through an upper central portion of the holder body 151 in a manner continuous with the receiving hole 151a.

The spring seat 152 is received in the receiving hole 151a. The spring seat 152 is formed therein with a mounting portion 152a and an outlet passage 152b. The outlet passage 152b is communicated with the outlet passage 151b.

The spring 153 is received in the receiving hole 151a, with one end thereof mounted to the mounting portion 142d of the outlet valve 142 and the other end thereof mounted to the mounting portion 152a of the spring seat 152. The spring 153 constantly urges the valve portion 142a of the outlet valve 142 toward the seat surface 141g of the valve body 141.

The proportional control valve 16 controls the flow rate of fuel flowing from the first supply passage 66 to the second supply passage 67.

The overflow valve 18 is arranged in the first return passage 68 to maintain pressure in the first supply passage 66 within a predetermined range.

A restriction 19 is formed in the second return passage 69. The restriction 19 determines the amount of flow of fuel per unit time which is returned to the fuel tank 47 via the second return passage 69.

Next, the operation of the fuel supply pump of the embodiment will be described.

When the shaft 7 is driven for rotation by an engine, not shown, each of the cams 8 rotates along with the shaft 7. The roller 103 of each tappet 10 is constantly held in contact with a cam surface 8a of the corresponding cam 8 by the urging force of the spring 13. Accordingly, as the cam 8 rotates, the roller 103 relatively rolls on the cam surface 8a. Since the cam surface 8a has rises and falls, the rolling of the roller 103 on the cam surface 8a causes vertical motion of the tappet 10 in accordance with the rises and falls of the cam surface 8a. The plunger 9 is moved vertically by the vertical motion of the tappet 10.

The feed pump 40 is connected to the shaft 7, so that when the shaft 7 rotates, the feed pump 40 is also driven to suck fuel from the fuel tank 47 and supply the fuel to the plunger chamber 28.

More specifically, when the plunger 9 moves downward from its top dead center position, pressure in the chamber 141a is lowered to reduce back pressure applied to the inlet valve 143, whereby pressure in the inlet passage 141b becomes relatively high. When the pressure in the inlet passage 141b becomes relatively high, fuel within the inlet passage 141b urges the inlet valve 143 upward against the back pressure applied to the inlet valve 143 and the urging force of the spring 144. As a result, the valve portion 143a of the inlet valve 143 moves away from the seat surface 141f to open the inlet passage 141b.

When the inlet passage 141b is opened, the fuel from the feed pump 40 is supplied to the plunger chamber 28 via the first and second supply passages 66, 67, the inlet passage 141b, the chamber 141a, and the communication passage 141c. This state is maintained until the plunger 9 reaches its bottom dead center position.

When the plunger 9 moves from its bottom dead center position to its top dead center position, the pressure in the chamber 141a is increased to increase the back pressure applied to the inlet valve 143, whereby the pressure in the inlet passage 141b becomes relatively low. As a result, the sum of the back pressure applied to the inlet valve 143 and the urging force of the spring 144 becomes larger than the force or pressure of the fuel within the inlet passage 141b for urging the inlet valve 143 upward, and hence the valve portion 143a of the inlet valve 143 is pressed against the seat surface 141f to close the inlet passage 141b.

When the inlet passage 141b is closed and the plunger moves further upward, the pressure in the chamber 141a is further increased to cause back pressure applied to the outlet valve 142 to exceed the sum of the urging force of the spring 153 of the valve holder 15 and a pressure downstream of the outlet valve 142. As a result, the valve portion 142a of the outlet valve 142 moves away from the seat surface 141g to open the outlet passage 145.

When the outlet passage 145 is opened, the fuel pressurized in the plunger chamber 28 is supplied to the common rail 48 via the communication passage 141c, the chamber 141a, the outlet passages 145, 152b, and the receiving hole 151a. This state is maintained until the plunger 9 reaches its top dead center position.

The common rail 48 distributes the supplied fuel to injectors 49. Each of the injectors 49 injects the fuel into a cylinder bore, not shown, in response to a signal from a control section, not shown.

The amount of the fuel to be supplied from the feed pump 40 to the plunger chamber 28 is adjusted by the proportional control valve 16 which controls the flow rate of fuel (amount of flow of fuel per unit time) flowing from the first supply passage 66 to the second supply passage 67. Excess fuel in the first supply passage 66 is returned to the fuel tank 47 via the first return passage 68. The amount of fuel delivered from the feed pump 40 to the first supply passage 66 is larger than that of the fuel flowing from the first supply passage 66 into the second supply passage 67, and hence the overflow valve 18 arranged in the first return passage 68 is constantly held open. The overflow valve 18 used in this state has the function of maintaining the pressure in the first supply passage 66 within the predetermined pressure range.

Even when fully closed, the proportional control valve 16 cannot stop the flow of fuel completely, so that some amount of fuel leaks from the first supply passage 66 into the second supply passage 67. The fuel having leaked into the second supply passage 67 is returned to the fuel tank 47 via the second return passage 69 and the first return passage 68.

Next, the advantageous effects of the embodiment will be described.

As shown in FIGS. 7 and 8, in the prior art, when a fuel is used which has an evaluation value of 500 by HFRR (standard of a test method of evaluating lubricity of a oil, with a evaluation value which indicates a lower lubricity as the value is larger), the wear amount of the sliding surface of the outlet valve is 0, and that of the seating surface of the same is extremely small. However, when a fuel of an HFRR evaluation value of 700 is used, both the wear amount of the sliding surface and that of the seating surface are markedly increased with the lapse of time.

On the other hand, according to the present embodiment, when a fuel having an HFRR evaluation value of 630 is used, the rate of increase in the wear amount of the sliding surface 142i and that of the seating surface 142h with the lapse of time is suppressed. Further, even in the case of the fuel having an HFRR evaluation value of 700 being used, the increase rate is suppressed to be close to that in the case of the fuel having an HFRR evaluation value of 630 being used.

As is apparent from the above facts, according to the present embodiment, since the CVD coating is applied to the surface of the outlet valve 142, it is possible to maintain the function of the outlet valve 142 over a long time period even when a low lubricity fuel is used.

Although in the above embodiment, the outlet valve 142 has the whole surface thereof coated by the CVD process, it suffices to apply CVD coating at least to the sliding surface 142i of the outlet valve 142, and it is more preferable to apply CVD coating to both the sliding surface 142i and seating surface 142h of the outlet valve 142.

Further, although in the above embodiment, description is made of the fuel supply pump for the common-rail fuel injection system, the fuel supply pump of the present invention can be also applied to apparatuses and systems other than the common-rail fuel injection system.

It is further understood by those skilled in the art that the foregoing is the preferred embodiment of the invention, and that various changes and modifications may be made without departing from the spirit and scope thereof.

What is claimed is:

1. A fuel supply pump including a valve body, and an outlet valve slidably inserted in an insertion hole formed in said valve body, for opening and closing the insertion hole,
wherein said outlet valve is coated by CVD coating.

2. A fuel supply pump according to claim 1, wherein said outlet valve has a sliding surface in contact with an inner peripheral surface of the insertion hole, and a seating surface for abutment with an outlet-side opening edge of the insertion hole, and
wherein a film is formed on the sliding surface by CVD coating.

3. A fuel supply pump according to claim 2, wherein a film is formed on the seating surface by CVD coating.

4. A fuel supply pump according to claim 1, wherein said outlet valve has a sliding surface in contact with an inner peripheral surface of the insertion hole, and a seating surface for abutment with an outlet-side opening edge of the insertion hole, and
wherein a film is formed on the seating surface by CVD coating.

5. A fuel supply pump according to claim 1, including an inlet valve slidably fitted in said outlet valve, for opening and closing an inlet passage formed in said valve body.

6. A fuel supply pump according to claim 2, including an inlet valve slidably fitted in said outlet valve, for opening and closing an inlet passage formed in said valve body.

7. A fuel supply pump according to claim 3, including an inlet valve slidably fitted in said outlet valve, for opening and closing an inlet passage formed in said valve body.

8. A fuel supply pump according to claim 4, including an inlet valve slidably fitted in said outlet valve, for opening and closing an inlet passage formed in said valve body.
